(19) United States
(12) Patent Application Publication
(10) Pub. No.: US 2026/0260913 A1
(43) Pub. Date: Sep. 3, 2026

(54) METHOD FOR STARTING A FUEL CELL SYSTEM, AND FUEL CELL SYSTEM

(71) Applicant: Robert Bosch GmbH, Stuttgart (DE)

(72) Inventor: Helerson Kemmer, Vaihingen (DE)

(21) Appl. No.: 19/164,787

(22) PCT Filed: Mar. 15, 2024
(86) PCT No.: PCT/EP2024/056938

§ 371 Date: Sep. 12, 2025

(30) Foreign Application Priority Data
Mar. 24, 2023 (DE) 10 2023 202 696.1

(51) Int. Cl. H01M 8/04225; H01M 8/04089; H01M 8/04111; H01M 8/04223; H01M 8/04302; H01M 8/04746; H01M 8/04791

(52) U.S. Cl. CPC H01M 8/04225; H01M 8/04097; H01M 8/04111; H01M 8/04231; H01M 8/04302; H01M 8/04753; H01M 8/04761; H01M 8/04791

(57) ABSTRACT

A method for starting a fuel cell system (1), wherein the fuel cell system (1) comprises a fuel cell stack (101), an air line (10), an exhaust line (12), and a fuel line (20) having a recirculation circuit (50), wherein, prior to starting, a first valve (61) in the air line (10) and a second valve (62) in the exhaust line (12) are closed. The method comprises the steps of:
a. starting an air compressor (11) in the air line (10);
b. opening a recirculation valve (65) in an exhaust recirculation line (66);
c. opening the first valve (61) and the second valve (62).

### BACKGROUND

The present invention describes a method for starting a fuel cell system, as well as a fuel cell system.

Hydrogen-based fuel cell systems are considered to be the mobility concept of the future, because they only emit water as exhaust and enable fast fueling times. In this context, cell systems need air and hydrogen for the chemical reaction within the cells. In order to supply the required amount of energy, the fuel cells arranged within a fuel cell system are interconnected to form so-called fuel cell stacks. The waste heat of the cells is in this case dissipated by means of a cooling loop and released to the surroundings. The hydrogen required for operating fuel cell systems is generally provided to the systems from high pressure tanks.

When a fuel cell system is started, there can be an increased concentration of hydrogen in the exhaust path, because hydrogen can diffuse through the membrane of the fuel cell during the standstill.

### SUMMARY

The problem addressed by the invention is a method and a fuel cell system having the features of the disclosure.

The method according to the invention and the fuel cell system according to the invention serve to provide an operating strategy for avoiding increased hydrogen concentration in the exhaust air after starting the fuel cell system. The method according to the invention offers the advantage that the gases trapped in the first and second valves, which have an increased concentration of hydrogen due to a diffusion of hydrogen through the membrane during the standstill, cannot directly enter the surroundings.

In the first purge of the cathode at a start of the fuel cell system, the hydrogen trapped in the cathode is recirculated between a first and second valve and fed back into the air line so that the hydrogen in the cathode can be left to react.

During a standstill of the fuel cell system, hydrogen diffuses over time from the anode through the membrane to the cathode and remains trapped therein. Upon the start of the fuel cell system, this hydrogen is purged by the air flow. This leads to an increased hydrogen concentration in the exhaust line.

The idea according to the invention is to open a recirculation valve to such an extent that a large portion of the amount of hydrogen trapped in the cathode before starting does not directly enter the surroundings but rather is recirculated. The recirculated amount of hydrogen is admixed with the fresh air in the air line and fed to the cathode. In the cathode, the recirculated amount of hydrogen reacts down to water.

The idea according to the invention can also be applied with an active exhaust recirculation. In this case, the exhaust recirculation line has a pump or compressor.

In the method according to the invention for starting a fuel cell system, the fuel cell system comprises a fuel cell stack, an air line, an exhaust line, and a fuel line having a recirculation circuit, whereby, prior to the starting process, a first valve in the air line and a second valve in the exhaust line are closed, said method comprising the following steps:
a. starting an air compressor in the air line;
b. opening a recirculation valve in an exhaust recirculation line;
c. opening the first valve and the second valve.

In order to ensure that a flow towards the air line occurs due to the pressure ratios, it is advantageous when a pressure regulator in the exhaust line is actuated before the first valve and the second valve are opened such that an increased pressure is set in the exhaust line. In this case, the pressure regulator can be advantageously set so as to produce a pressure greater than 1.5 bar.

It is advantageous when the throttling or dethrottling of the pressure regulator is controlled by measuring the cathode outlet pressure, because this enables an exact setting of the pressure regulator.

A closing of the recirculation valve after a specified time interval is advantageous, because the increased hydrogen concentration formed during the standstill of the fuel cell system is then degraded.

A particular advantage arises due to the increased accuracy when the recirculation valve is closed after a measurement or calculation has revealed that the hydrogen concentration in the exhaust line has decreased.

It is advantageous when the pressure regulator is de-throttled after filling the cathode with oxygen-containing air, because after starting, increased pressure is no longer needed in the exhaust line of the fuel cell system.

When method steps a.), b.), c.) are performed almost simultaneously and quickly, this is advantageous because damage to the valves due to an undesirable excessive high pressure can be prevented.

A particular advantage arises when the throttling or dethrottling of the pressure regulator occurs in a pilot-controlled manner by approaching of one or two predetermined positions, because the pilot-controlled operation also works well with a frozen pressure sensor.

The method according to the invention can be used in particular in fuel cell-powered motor vehicles. However, it is also conceivable to use the method in other fuel cell-powered transportation means, such as cranes, ships, rail vehicles, flying objects, or even in stationary fuel cell-powered objects.

### BRIEF DESCRIPTION OF THE DRAWINGS

Shown are:

FIG. 1 a schematic representation of a fuel cell system according to the invention and

FIG. 2 a flowchart of the individual steps of a method according to the invention.

### DETAILED DESCRIPTION

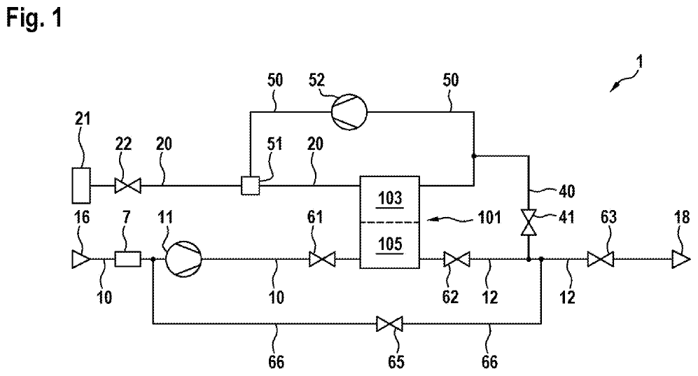

FIG. 1 shows a schematic topology of a fuel cell system 1 according to a first exemplary embodiment of the invention, having at least one fuel cell stack 101. The at least one fuel cell system 1 comprises an air line 10, an exhaust line 12, and a fuel line 20. The at least one fuel cell stack 101 can be used for mobile applications with a high power specification, for example in trucks, or for stationary applications, for example in generators.

The air line 10 serves as an air supply line for supplying air from the surroundings to a cathode 105 of the fuel cell stack 101 via an inlet 16. Components needed for the operation of the fuel cell stack 101 are arranged in the air line 10. An air compressor 11 and/or compactor 11, which compresses and/or draws in the air in accordance with the respective operating conditions of the fuel cell stack 101, is arranged in the air line 10. A heat exchanger which heats the air in the air line 10 can be located downstream of the air compressor 11 and/or the compactor 11.

Further components, e.g. a filter 7 and/or a humidifier and/or valves, can be provided in the air line 10. Air containing oxygen is made available to the fuel cell stack 101 via the air line 10.

The fuel cell system 1 also comprises an exhaust line 12, in which water and other components of the air from the air line 10 are transported into the surroundings via an outflow 18 after passing through the fuel cell stack 101. The exhaust of the exhaust line 12 can also contain hydrogen (H2), because portions of the hydrogen can diffuse through the membrane of the fuel cell stack 101. Diffusion of the hydrogen also occurs when the fuel cell system 1 is turned off.

Hydrogen can also be transported into the exhaust line 12 via a purge line 40 having a purge valve 41.

The exhaust line 12 is connected to the air line 10 upstream of the air compressor 11 and/or compactor via an exhaust recirculation line 66. A recirculation valve 65 is arranged within the exhaust recirculation line 66. When the recirculation valve 65 is opened, exhaust from the exhaust line 12 can flow back into the air line 10.

A first valve 61 is arranged in the air line 10 and a second valve 62 is arranged in the exhaust line 12. By closing the first valve 61 and the second valve 62, a volume V around the cathode is sealed so that no air can flow from the air line 10 into the volume V and no exhaust can escape from the volume. By closing the first valve 61 and the second valve 62, the volume V and the cathode 105 arranged therein can be held at a fixed pressure level or protected against an undesired pressure drop.

A pressure control valve 63 is arranged in the exhaust line 12, which can throttle the flow in the exhaust line 12 so that different pressures can be adjusted upstream of the pressure control valve.

The fuel cell system 1 can moreover comprise a cooling loop designed to cool the fuel cell stack 101. The cooling loop is not shown in FIG. 1, because it is not part of the invention.

A high-pressure tank 21 and a shut-off valve 22 are located in the inflow of fuel line 20. Additional components can be arranged in the fuel line 20 so as to supply fuel to an anode side 103 of the fuel cell stack 101 as needed.

In order to always adequately supply the fuel cell stack 101 with fuel, there is a need for an over-stoichiometric metering of fuel via the fuel line 20. The excess fuel, and also certain amounts of water and nitrogen that diffuse through the cell membranes to the anode side, are recirculated in a recirculation circuit 50 and mixed with the metered fuel from the fuel line 20.

Various components, such as a jet pump 51 operated with the metered fuel or a blower 52, can be installed in order to drive the flow in the recirculation circuit 50. A combination of jet pump 51 and blower 52 are possible as well.

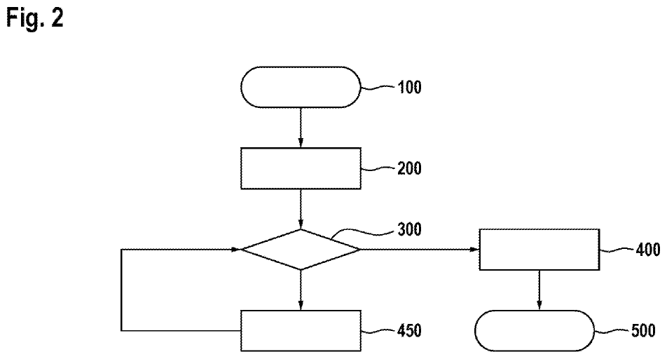

FIG. 2 shows a flowchart of the individual steps of a method according to the invention for starting a fuel cell system 1.

In a method step 100, the fuel cell system 1 is started. Prior to the starting process, the first valve 61 in the air line 10 and the second valve 62 in the exhaust line 12 must be closed for the method to be performed properly.

In a method step 200, the air compressor 11 is started in the air line 10. This is followed by an opening of the recirculation valve 65 in the exhaust recirculation line 66 and an opening of the first valve 61 and the second valve 62. The individual steps in the method step can be carried out either briefly in succession or almost simultaneously.

In a method step 300, it is checked whether an increased hydrogen concentration has degraded in the exhaust line 12. This can be done with the aid of a threshold value. If this is the case, the recirculation valve 65 is closed in method step 400, and the method according to the invention is ended in method step 500.

If the hydrogen concentration in the exhaust line 12 has not yet been reduced, the method step involves either leaving the recirculation valve 65 in the previous position or opening it more or less depending on the hydrogen concentration, so that the amount of exhaust flowing into the air line 10 via the recirculation line 66 can be changed.

After some time, the hydrogen concentration in the exhaust line 12 is checked again in method step 300.

In order to produce an increased pressure in the exhaust line 12 relative to air line 10, a pressure regulator 63 in the exhaust line 12 can be controlled in order to set an increased pressure in the exhaust line 12.

Preferably, this can be done prior to opening the first valve 61 and the second valve 62. The pressure regulator 63 can, for example, be set so as to produce a pressure greater than 1.5 bar. Alternatively, the throttling or dethrottling of the pressure regulator 63 can be controlled by measuring the cathode outlet pressure or performed in a pilot-controlled manner by approaching one or two previously established positions.

In order to avoid excessive mass flow at the start of the fuel cell system 1, the mass flow of the air compressor 11 can be slowly increased.

Instead of checking the hydrogen concentration in method step 300, the recirculation valve 65 can also be closed after a specified time interval.

1. A method for starting a fuel cell system (1), wherein the fuel cell system (1) comprises a fuel cell stack (101), an air line (10), an exhaust line (12), and a fuel line (20) having a recirculation circuit (50), wherein, prior to starting, a first valve (61) in the air line (10) and a second valve (62) in the exhaust line (12) are closed, the method comprising:
a. starting an air compressor (11) in the air line (10);
b. opening a recirculation valve (65) in an exhaust recirculation line (66);
c. opening the first valve (61) and the second valve (62).

2. The method according to claim 1, wherein, prior to opening the first valve (61) and the second valve (62), a pressure regulator (63) in the exhaust line (12) is actuated such that an increased pressure is set in the exhaust line (12).

3. The method according to claim 2, wherein the pressure regulator (63) is set so as to produce a pressure greater than 1.5 bar.

4. The method according to claim 1, wherein method steps a.), b.), and c.) are performed at nearly the same time.

5. The method according to claim 2, wherein a throttling or dethrottling of the pressure regulator (63) is controlled by measuring a cathode outlet pressure.

6. The method according to claim 2, wherein a throttling or dethrottling of the pressure regulator (63) is performed in a pilot-controlled manner by approaching one or two predetermined positions.

7. The method according to claim 1, wherein a mass flow of the air compressor (11) is slowly increased.

8. The method according to claim 1, wherein after a specified time interval, the recirculation valve (65) is closed.

9. The method according to claim 1, wherein after a hydrogen concentration in the exhaust line (12) has decreased, the recirculation valve (65) is closed.

10. The method according to claim 1, wherein a degree of opening of the recirculation valve (65) is dependent on a hydrogen concentration in the exhaust line (12).

11. A fuel cell system having a fuel cell stack (101), an air line (10), an exhaust line (12), and a fuel line (20) with a recirculation circuit (50), wherein the fuel cell system is configured so as to perform a method according to claim 1.
